(19) United States
(12) Patent Application Publication
(10) Pub. No.: US 2007/0140229 A1
(43) Pub. Date: Jun. 21, 2007

(54) METHOD FOR CELL REORDERING, METHOD AND APPARATUS FOR CELL PROCESSING USING THE SAME

(76) Inventor: Dezhi Tang, Shenzhen (CN)

Correspondence Address: MCANDREWS HELD & MALLOY, LTD, 500 WEST MADISON STREET, SUITE 3400, CHICAGO, IL, 60661, US

(21) Appl. No.: 11/560,581

(22) Filed: Nov. 16, 2006

(30) Foreign Application Priority Data
Nov. 16, 2005 (CN) 200510101482.0

(51) Int. Cl. H04L 12/50; H04J 3/06

(52) U.S. Cl. 370/360; 370/503

(57) ABSTRACT

A method for cell reordering, a method and a related apparatus for cell processing are disclosed. The method for cell reordering includes steps of inserting time flags and sequence flags into cells by a sequence flag generating module; sending the cells from a source module to an object module; and reordering a multiple pieces of the enqueue information of the cells by a reordering module according to the time flags and the sequence flags. The time for each cell occupying RCB during reorder can be strictly controlled, the reorder operation can be done after the occupied time reaches the limit defined in the algorithm, and the demand for RCB buffer capacity can be lowered, whereby the method solves the significant problem in extensibility design of the multi-stage switch fabric with large capacity.

### RELATED APPLICATIONS

This patent application makes reference to, claims priority to and claims benefit from Chinese Patent Application No. 200510101482.0 filed on Nov. 16, 2005, which is explicitly incorporated herein by reference in its entirety.

### BACKGROUND OF THE INVENTION

The present invention relates generally to the communication field, and more particularly, to a method for cell reordering, a method for cell processing and an apparatus for cell processing.

The switch fabric is known as a core module in a router, which switches the packets or cells (data packet units inputted into the switch fabric) between a plurality of ports, that is, it switches the cells at an input port to a respective output port. The switch fabric generally includes two types, i.e., the Time Division Switching Fabric and the Space Division Switching Fabric.

Typically, the Time Division Switch Fabric may include a share buffer and share bus switch architecture, and is generally used in devices with small switching capacity due to its poor extensibility. A typical type of the Space Division Switch Fabric is a multi-stage switch fabric, such as CLOS architecture, Banyan architecture and Crossbar, etc. It is frequently used in devices with large switching capacity because of its excellent extensibility.

It is a basic requirement of the switch fabric that the cells switched out still need to retain the previous order. In the multi-stage switch fabric, generally, one cell (or packet) can reach the object module through several paths, but the time delays of the several paths are highly impossible to be the same, which may thereby cause an out-of-order phenomenon when the cells of one stream (from the same input port to the same output port) reach the object module. Accordingly, there is generally a need to solve the problem of reordering in the multi-stage switch fabric.

Since the out of order for cells may generally occur in the second-stage of the switch fabric, it generally can be observed at the entrance of the last stage. A solution in the prior art for solving the problem of reordering includes, reordering the out-of-order cells first at the entrance of the last stage of the switch fabric and then sending them into the following logic for processing, including sending into a share buffer, enqueuing and scheduling, etc. As a result, it is inevitable to set some cell buffers at the entrance of the last stage to store the out-of-order cells in advance and then to send them into a share buffer of the chip after the next desired cell arrives, for carrying out the follow-up switch processing.

The operation of reorder requires certain share buffer spaces known as the Reorder Cell Buffer (RCB), for storing the cells that have not been reordered. As the capacity of the switch fabric extends, the RCB capacity required by the solution described above increases rapidly. However, if the RCB capacity becomes too large, there will be a problem for its implementation.

FIG. 1 shows the architecture of a three-stage switch fabric 100 in prior art. In this switch fabric, the cells input from any input module can reach any output module via m paths, which are exemplarily shown as three paths in the figure, i.e. path one 102, path two 104, and path three 106. Due to the different time delays of wiring in the m paths and the different processing time delays of the second-stage chip 110, when the cells switched out from the first-stage chip 108 and passing through different paths reach the third-stage chip 112, their order may not retain as before. Thereby, in such a switch fabric, it generally requires solving the problem before sending the cells out from the object module. Alternatively, the problem can be solved by another solution that reorders according to sequence flags, but the RCB used during the reorder increases rapidly along with the extension of capacity of the switch fabric, and thereby the cost will be too high.

Supposing there are 64 source modules (the first stage) in a switch fabric and supposing the number of the paths for the cells sent by a source module to an object module is 36, the maximum time delay between different paths is 4 cell periods, and the size of a cell is 72 bytes, then the maximum buffer required will be 64×{36×4□1}×72×8=5 Mbit, wherein 64 represents the number of the source modules, 36 represents the number of the paths, 72 represents the number of bytes occupied by each cell, and 8 represents one byte equals to 8 bit.

### BRIEF SUMMARY OF THE INVENTION

An object of some embodiments of the present invention is to provide a method for cell reordering, which can substantially obviate the problem in prior art that the cell reordering operation may occupy too much buffer space, and further to provide a method as well as an apparatus for cell processing.

In a first aspect, the present invention provides a method for cell reordering, including the following steps: inserting time flags and sequence flags into cells and sending the cells from a source module to an object module by a sequence flag generating module; and reordering the multiple pieces of the enqueue information of the cells by a reordering module according to the time flags and the sequence flags, which are sent from the source module and received by the object module.

In the above method, the step of inserting time flags and sequence flags into cells and sending the cells from a source module to an object module by a sequence flag generating module can further include: the sequence flag generating module inserting the same time flag into the cells of the same stream outputted at the same time; the sequence flag generating module inserting different sequence flags into the cells of the same stream outputted at the same time.

In the above method, the time flags can be arranged by a unified rule and the number of the time flags can be at least twice of the number of cell period included in the maximum delay difference between the two different paths; and the sequence flags can be arranged by a unified rule, with the number thereof equal to the number of paths from a source module to an object module.

In the above method, the step of reordering the multiple pieces of the enqueue information of the cells by a reordering module according to the time flags and the sequence flags can further include: storing the cells successively into a share cell buffer module by the arriving order of the cells at the object module and extracting the enqueue information of the cells by an input processor module; and sending the multiple pieces of the enqueue information by the arriving order of the cells at the object module to the reordering module for reordering by the input processor module.

In the above method, the step of sending the multiple pieces of the enqueue information by the arriving order of the cells at the object module to the reordering module for reordering by the input processor module can further include: allocating the multiple pieces of the enqueue information from the input processor module to the corresponding reordering buffer according to the serial number of the source module by a multipath allocator; starting to time the time flag by each reordering buffer in the case that a cell having a unique time flag, wherein when a timing value becomes equal to or more than the maximum time delay, the reordering buffer determining whether all of the multiple pieces of the enqueue information of the cells in a time range prior to the time flag have been outputted, and if so, outputting the enqueue information of the cell having the time flag; if not, forcedly outputting the multiple pieces of the enqueue information of the cells which are not outputted till then, and outputting the enqueue information of the cell having the time flag; and performing the time-division multiplexing on the output of the reordering buffers by polling by a multiplexer.

In the above method, the step of reordering the multiple pieces of the enqueue information of the cells by a reordering module according to the time flags and the sequence flag can further include: sending the multiple pieces of the reordered enqueue information by the reordering module to a queue management module for queuing.

In the above method, at the step of starting to time the time flag by each reordering buffer in the case that a cell having a unique time flag, the time flag can be timed by, for example, an aging counter.

In order to better realize the above object, another aspect of the present invention provides a method for cell processing, including the steps of: inserting time flags and sequence flags into cells by using a sequence flag generating module, and reordering the multiple pieces of the enqueue information of the cells inserted by the time flags and the sequence flags in the object module by a reordering module; and outputting the multiple pieces of the enqueue information reordered successively, and scheduling the corresponding cells out from the share cell buffer module.

The above method can further include a step between the step of inserting time flags and sequence flags into cells by a sequence flag generating module, and reordering the multiple pieces of the enqueue information of the cells inserted by the time flags and the sequence flags in the object module by a reordering module and the step of outputting the multiple pieces of the enqueue information reordered successively and scheduling the corresponding cells out from the share cell buffer module, and the step is queuing the reordered multiple pieces of the enqueue information into an output sequence by a queue management module.

In the above method, the step of inserting time flags and sequence flags into cells by a sequence flag generating module, and reordering the multiple pieces of the enqueue information of the cells inserted by the time flags and the sequence flags in the object module by a reordering module can further include: inserting the time flags and the sequence flags into cells by the sequence flag generating module, and sending the cells from the source module to the object module; and reordering the multiple pieces of the enqueue information of the cells by the reordering module according to the time flags and the sequence flags of the cells received by the object module from the source module.

In the above method, the step of inserting time flags and sequence flags into cells by using the sequence flag generating module can further include: inserting the same time flag into the cells of the same stream outputted at the same time by the sequence flag generating module; and inserting different sequence flags into the cells of the same stream outputted at the same time by the sequence flag generating module.

In the above method, the step of reordering the multiple pieces of the enqueue information of the cells by the reordering module according to the time flags and the sequence flags of the cells received by the object module from the source module can further include: storing the cells successively into a share cell buffer module by the arriving order of the cells at the object module and extracting the enqueue information of the cells by an input processor module; and sending the multiple pieces of the enqueue information by the input processor module by the arriving order of the cells at the object module to a reordering module for reordering.

In the above method, the step of sending the multiple pieces of the enqueue information by the input processor module by the arriving order of the cells at the object module to a reordering module for reordering can further include: allocating the multiple pieces of the enqueue information from the input processor module to the corresponding reordering buffer according to the serial number of the source module by a multipath allocator; starting to time the time flag by each reordering buffer, in the case that one cell having a certain time flag is the unique one having such a flag, wherein, when the timing value becomes equal to or more than the maximum time delay, the reordering buffer determining whether all of the multiple pieces of the enqueue information of the cells in a certain time range prior to that of the time flag have been outputted, and if so, outputs the enqueue information of the cell having the time flag; if not, enforces to output the multiple pieces of the enqueue information of the cells in the prior time range that have not been outputted, and outputs the enqueue information of the cell having the time flag; and performing the time-division multiplexing on the output of the reordering buffers by polling by the multiplexer.

In order to better realize the above object, in yet another aspect, the present invention provides an apparatus for cell processing, including: a reordering module, for receiving multiple pieces of the enqueue information of cells from an input processor module and reordering the multiple pieces of the enqueue information of the cells according to the time flags and the sequence flags carried by the cells.

The above apparatus can further include: an input processor module, for receiving cells from the first stage chip, storing the cells into a share cell buffer module and extracting the multiple pieces of the enqueue information of the cells, and outputting the multiple pieces of the enqueue information of the cells into the reordering module by the arriving order of the cells at a third stage chip; a share cell buffer module, for storing the cells received by the input processor module; and a queue manager, for receiving the multiple pieces of the enqueue information of the cells reordered by the reordering module, i.e., queuing the cells overcoming the out-of-order problem.

The reordering module can further include: a multipath allocator, for receiving the multiple pieces of the enqueue information of the cells from the input processor module and allocating the multiple pieces of the enqueue information to the corresponding reordering buffer according to the serial number of the source module; a plurality of reordering buffers, for reordering the multiple pieces of the enqueue information, each corresponding to one source module, and for a reordering buffer, in the case that a cell have a unique time flag, it starting to time the time flag, wherein when a timing value becomes equal to or more than the maximum time delay, the reordering buffer determines whether all of the multiple pieces of the enqueue information of the cells in a certain time range prior to that of the time flag have been outputted, and if so, outputs the enqueue information of the cell having the time flag; if not, enforces to output the multiple pieces of the enqueue information of the cells in the prior time range that have not been outputted, and outputs the enqueue information of the cell having the time flag; and a multiplexer, for performing the time-division multiplexing on the output of the reordering buffers by polling.

According to some embodiments of the present invention, the cells can be inserted by the time flag and the sequence flag in the source module, the multiple pieces of the enqueue information for the cells can be ordered in the object module according to the time flag and the sequence flag and then the cells can be scheduled. Moreover, in some embodiments of the present invention, the time for each cell occupying RCB during reorder can be strictly controlled, the reorder operation can be done after the occupied time reaches the limit defined in the algorithm, and the demand for RCB buffer capacity can be lowered, whereby it solves the significant problem in extensibility design of the multi-stage switch fabric with large capacity.

### BRIEF DESCRIPTION OF SEVERAL VIEWS OF THE DRAWINGS

FIG. 1 shows the architecture of a typical three-stage switch fabric in prior art;

FIG. 2 is a block diagram showing an apparatus for cell processing according to an embodiment of the present invention;

FIG. 3 is a block diagram showing the internal architecture of a reordering module according to an embodiment of the present invention;

FIG. 4 is a flow chart showing a method for cell reordering according to an embodiment of the present invention;

FIG. 5 is a schematic diagram showing the structure of a reorder cell buffer according to a preferred embodiment of the present invention;

FIG. 6 is a schematic diagram showing that a source module sends cells and then the cells can reach an object module via four paths having different time delays according to a preferred embodiment of the present invention;

FIG. 7 is a schematic diagram showing a rule of cells reaching an object module according to a preferred embodiment of the present invention;

FIG. 8 is a schematic diagram showing a reorder process of the cells received by an object module according to a preferred embodiment of the present invention;

FIG. 9 is a flow chart showing a method for cell processing according to an embodiment of the present invention.

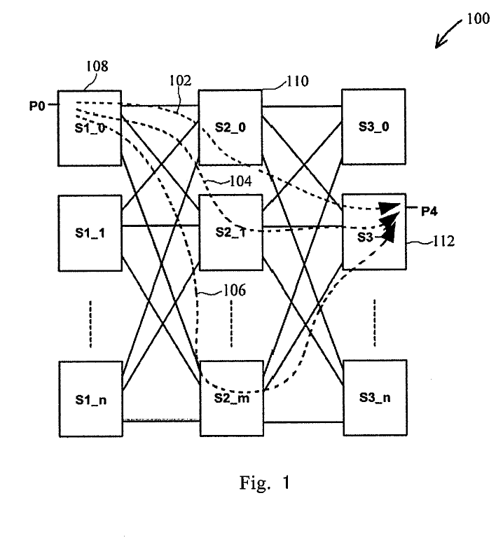

### DETAILED DESCRIPTION OF THE INVENTION

According to an embodiment of the present invention, switched cells are numbered successively based on their previous order, i.e. inserting time flags and sequence flags. As a part of a cell header, the time flag and the sequence flag, together with the cell payload, are switched to an object module. In the object module, the cells are ordered. And the input processor module stores the incoming cells switched via different paths into a share cell buffer module of the chip successively in their arriving order, but without being enqueued. The multiple pieces of information required for enqueue are sent to the reordering module for ordering and then are sent to the queue management module successively to be queued so as to be outputted in sequence, that is, in accordance with an embodiment of the present invention, the reordering module only performs to buffer and to process the information in relation to enqueue.

The details of some embodiments of the present invention will be described with reference to the accompanying drawings, which however only serve as an interpretation to the invention but not as limitations.

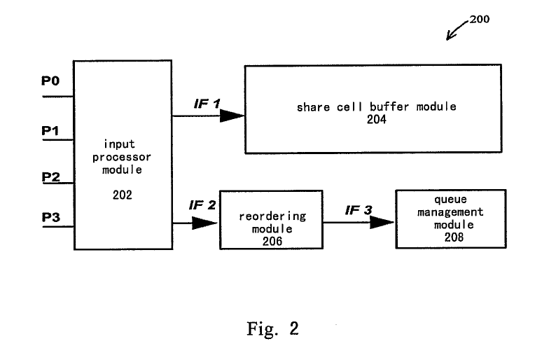

FIG. 2 is a block diagram showing a cell processing apparatus 200 according to an embodiment of the present invention. After the time flags and the sequence flags are inserted in the cells in the first stage chip, the cells are processed in the cell processing apparatus 200. FIG. 2 indicates the location of the reordering module 206 in the chip, wherein a share cell buffer module 204 serves as a share buffer for all the cells in the chip, and a queue management module 208 can queue the multiple pieces of the enqueue information of the cells. The cells scheduled according to the enqueue information are sent out of the switch fabric successively. In the embodiment, the incoming cells switched via different paths can be stored into the share cell buffer module 204 of the chip successively in their arriving order, but without enqueue. Meanwhile, the multiple pieces of the information required for enqueue (referred to as “multiple pieces of the enqueue information” for short) are sent to the reordering module 206 by the arriving order of the cells at the object module, and after they are ordered in the reordering module 206, the multiple pieces of the enqueue information are sent to the queue management module 208 to be queued, that is, the reordering module 206 only performs to buffer and to process the multiple pieces of the enqueue information. As a result, an advantage of the embodiment of the present invention is that it is not necessary to buffer such cells that have not been ordered in the input processor module 202, thereby saving a large amount of resources.

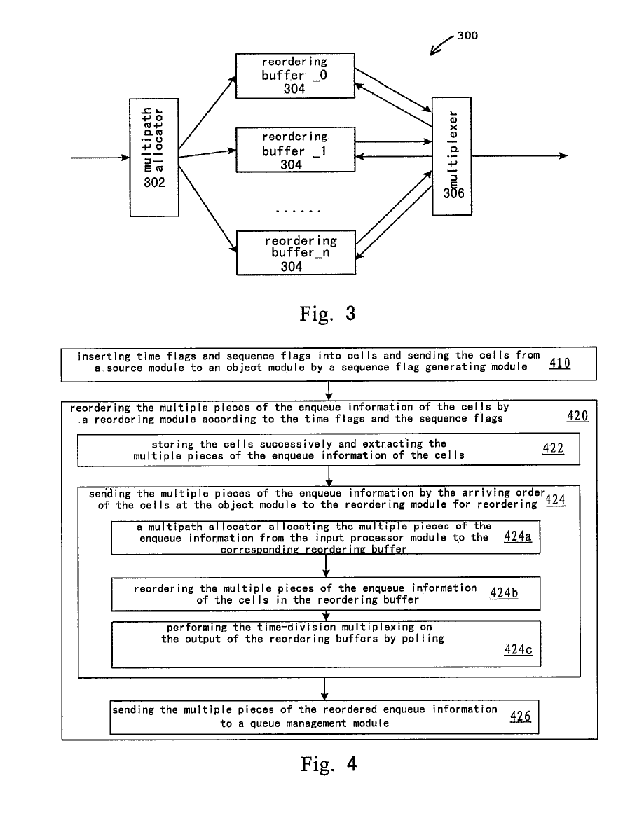

FIG. 3 is a block diagram showing the internal architecture of a reordering module 206 according to an embodiment of the present invention. The reordering module 206 includes a multipath allocator 302, for receiving the multiple pieces of the enqueue information of the cells from the input processor module and allocating the multiple pieces of the enqueue information to the corresponding reordering buffer 304 according to the number of the source module; a plurality of reordering buffers 304, each corresponding to a source module, for ordering the multiple pieces of the enqueue information corresponding to the cells of the source module; a multiplexer 306, for performing a time-division multiplexing processing the multiple pieces of the enqueue information outputted by the plurality of reordering buffers 304.

In accordance with one embodiment of the present technology, each source module in the switch fabric preferably has a corresponding reordering buffer 304 located in the object module. The reordering buffer 304 buffers the multiple pieces of the enqueue information, other than cells. The multiple pieces of the enqueue information may include information such as an address in the share buffer of a cell and the cell priority. The multiple pieces of the enqueue information from the input processor module is allocated by the multipath allocator 302 to the corresponding reordering buffer 304 according to the source module number and is ordered in the corresponding reordering buffer. It should be noted that it is only necessary to reorder the cells from the same source module in this embodiment, but not from the different ones.

In accordance with some embodiments of the present invention, for each reordering buffer, in the case that a cell having a certain time flag is the unique one having such a flag, the reordering buffer will start to time the time flag. And when the timing value becomes equal to or larger than the maximum time delay, the reordering buffer determines whether all of the multiple pieces of the enqueue information of the cells in a certain time range prior to that of the time flag have been outputted. If so, outputs the multiple pieces of the enqueue information of the cell having the time flag; if not, enforces to output the multiple pieces of the enqueue information of the cells in the prior time range that have not been outputted, and then outputs the multiple pieces of the enqueue information of the cell having the time flag. Preferably, the reordering buffer is configured with an aging counter for timing each of the unique time flag.

A plurality of streams may co-exist (the stream is defined to include all the cells from a source module to an object module) in the system, and therefore each object module may have a plurality of reordering buffers 304. As a result, it is highly possible that several reordering buffers 304 accomplish reordering at the same time and output the multiple pieces of the enqueue information reordered. Thereby, in accordance with some embodiments of the present invention, at the output port of the plurality of reordering buffers 304, it is necessary to perform the time-division multiplexing processing, which can be accomplished by the multiplexer 306. The multiplexer 306 can arbitrate the request from each reordering buffer 304 and determine which reordering buffer 304 can output multiple pieces of the enqueue information by polling.

FIG. 4 is a flow chart showing a method for cell reordering according to an embodiment of the present invention. The method includes the following steps in this embodiment:

At step 410, the time flag and the sequence flag are inserted into a cell by the sequence flag generating module, and the cell was sent from the source module to the object module.

At step 420, the reordering module reorders multiple pieces of the enqueue information of the cells according to the time flag and the sequence flag of the cells received by the object module from the source module.

In this embodiment, the time flag (tf) is used to solve the out-of-order problem in time, i.e. sending earlier but arriving later or sending later but arriving earlier. If the cells of the same stream are outputted at the same time, the same time flag should be inserted into those cells. The maximum of the time flag is determined by the maximum difference of path delays. The sequence flag (sf) is used to solve the out-of-order problem in space. If the cells of the same stream are outputted at the same time, they must have different sequences and thus different sequence flags should be inserted into them. The time flags are arranged by a unified rule and the number thereof is at least twice of the number of cell period included in the maximum delay difference between two different paths. And, the sequence flags are arranged by a unified rule, with their number equal to the number of the paths from one source module to one object module.

According to this embodiment, both the time flag and the sequence flag can be inserted into the cell header by the sequence flag generating module and can be switched to the object module together with the cell payload. Preferably, the time flag of each stream may be added by 1 every time a cell slot passes. The time flag may be returned to zero and counts again after reaching the maximum. The bits required by the time flag and the sequence flag can be determined by: the maximum of the differences between the path delays SKEWmax as to cells reaching the object module via different paths, and the number of the paths PATH_NUM from one input port to one output port. The value range of the time flags can be defined within 0˜(SKEWmax×2−1), while the value range of the sequence flags can be defined within 0˜(PATH_NUM−1). Assuming the PATH_NUM is equal to 4, and the SKEWmax is equal to two cell periods, and then 2 bits for the time flags and 2 bits for the sequence flags are required. The arranging rule of the time flags and the sequence flags may change with the agreement between the source module and the object module.

The reordering module can reorder the multiple pieces of the enqueue information of the cells according to the time flag and the sequence flag, and this may include the following steps:

At step 422, the input processor module stores the cells successively into the share cell buffer module by the arriving order of the cells at the object module, and extracts the enqueue information of the cells.

At step 424, the input processor module sends the multiple pieces of the enqueue information to be reordered to the reordering module by the arriving order of the cells at the object module.

At step 426, the multiple pieces of the reordered enqueue information are sent to a queue management module to be queued.

According to some embodiments of the present invention, step 424 may further include the following steps.

At step 424a, the multipath allocator allocates the multiple pieces of the enqueue information from the input processor module to a corresponding reordering buffer in accordance with the number of the source module.

At step 424b, for each reordering buffer, in the case that one cell having a certain time flag is the unique one having such a flag, the reordering buffer starts to time the time flag. And when the timing value becomes equal to or larger than the maximum time delay, the reordering buffer determines whether all of the multiple pieces of the enqueue information of the cells in a certain time range prior to the “time flag” have been outputted. If so, outputs the multiple pieces of the enqueue information of the cell having the time flag; if not, firstly, enforces output of the multiple pieces of the enqueue information of the cells in the prior time range that has not been outputted, and then outputs the multiple pieces of the enqueue information of the cell having the time flag.

The reordering buffer times the multiple pieces of the enqueue information by using the aging counter. In the case that one cell having a certain time flag is the unique one having such a flag, the aging counter sets the aging enabling Time_start to 1, and begins timing. If the aging time Time counted by the aging counter is equal to or more than a threshold Tth of the aging time, the aging counter sets the aging expiration Time_over to be 1, and determines whether all of the multiple pieces of the enqueue information of the cells in a certain time range prior to the time flag have been outputted. And if so, outputs the multiple pieces of the enqueue information of the cell having the time flag; if not, firstly, enforces output of the multiple pieces of the enqueue information of the cells in the prior time range that has not been outputted, and then outputs the multiple pieces of the enqueue information of the cell having the time flag.

At step 424c, the multiplexer performs the time-division multiplexing on the output of the reordering buffers by polling.

Herein, the aging time Time is a time in which the cells are waiting in the RCB for completing the reorder; Time [0] represents the time in which the cell having a time flag of 0 stays in the RCB; and Time [N] represents the time in which the cell having a time flag of N stays in the RCB. When several cells having the time flag of 0 stay in the RCB, Time [0] may represent the staying time of an “earliest-arriving cell” among these cells.

The aging enabling Time_start is defined so that if a cell having a certain time flag detects it is the single one having such a flag when reaching the object module, it starts to be timed, that is, Time_start [ts] is set to 1 and at the same time Time [ts] begins timing.

The aging expiration Time_over is defined so that if the multiple pieces of the enqueue information of all the cells having a certain time flag have been reordered, such cells (or the multiple pieces of the enqueue information of such cells) can be referred to as being in a state of aging expiration. If the cells having the time flag of 0 are in the state of aging expiration, Time_over [0] is set to 1, . . . , and if the cells having the time flag of N are in the state of aging expiration, Time_over [N] is set to 1. As it will be described bellow, both “natural aging” and “compulsory aging” can bring the cell into the state of aging expiration.

The threshold “Tth” of the aging time means that once the aging time is equal to or more than the threshold Tth of the aging time, Time_over will be set to 1, representing the state of aging expiration. The value of Tth is determined only by the maximum difference n between different path delays, that is, Tth=n.

The natural aging means that when the aging time is equal to or more than the threshold Tth of the aging time, it leads to the state of aging expiration, and this process is referred to as the natural aging.

The compulsory aging means that in the state of aging expiration, in addition to setting the Time_over value of the cells having the aging time equal to or more than the threshold Tth to 1, the Time_over of some other cells having time flags earlier in a predetermined range (the cells that are not in the state of aging expiration, but yet cannot be reordered correctly by the natural aging in the object module due to different transmission paths and delays of the cells) is forced to be set to 1, and this process is referred to as the compulsory aging.

The aging scheduling output means that because it is highly possible for the multiple pieces of the enqueue information of the cells having different time flags to come into the state of aging expiration at the same time, it is necessary to select the multiple pieces of the enqueue information of a group of the cells in the state of aging expiration and to output them from the reordering buffer and to schedule the respective cells out from the cell buffer to release the relating memory spaces, and this process is referred to as the aging scheduling output.

The method adopted here in accordance with one embodiment of the present invention for scheduling output will be exemplarily described. In the case that there are N (N is even) time flags, the states of the N time flags are designated by a N-digit sequence, wherein the initial digit and the last digit of the N-digit sequence is regarded as the neighboring digits, and 1 represents the timing value of a time flag is equal to or more the time delay, while 0 represents the timing value of a time flag is less than the time delay. In accordance with one embodiment, the method finds the continuous N/2 digits with the neighboring digits being 0 in the N-digit state sequence, and then determines whether the first digit after the continuous N/2 digits is 1. If the first digit is 1, the method outputs the multiple pieces of the enqueue information of the cells having the time flag corresponding to the first digit; and if it is 0, it continues to determine whether the next digit is 1 and until find a state digit being 1, the method outputs the multiple pieces of the enqueue information of the cells having the time flag corresponding to the found digit. In other cases, for example, the method can report an error of reorder, and select a cell having a timing value of the time flag equal to or larger than the time delay and output the multiple pieces of the enqueue information thereof.

If the maximum difference between different path delays is 4, for example, the value range of the time flags will be then 0 to 7, and the method for aging scheduling output can be described as shown in the following table.

| {time_over[0], time_over[1], . . . , time_over[7]} | Aging scheduling |
|---|---|
| 1 represents the aging expiration, x can be 1 or 0 | output |
| 1xxx0000 | ts0 |
| 01xxx000 | ts1 |
| 001xxx00 | ts2 |
| 0001xxx0 | ts3 |
| 00001xxx | ts4 |
| x00001xx | ts5 |
| xx00001x | ts6 |
| xxx00001 | ts7 |
| Others | report an error of |
| | reorder, and select |
| | an output for aging |
| | expiration. |

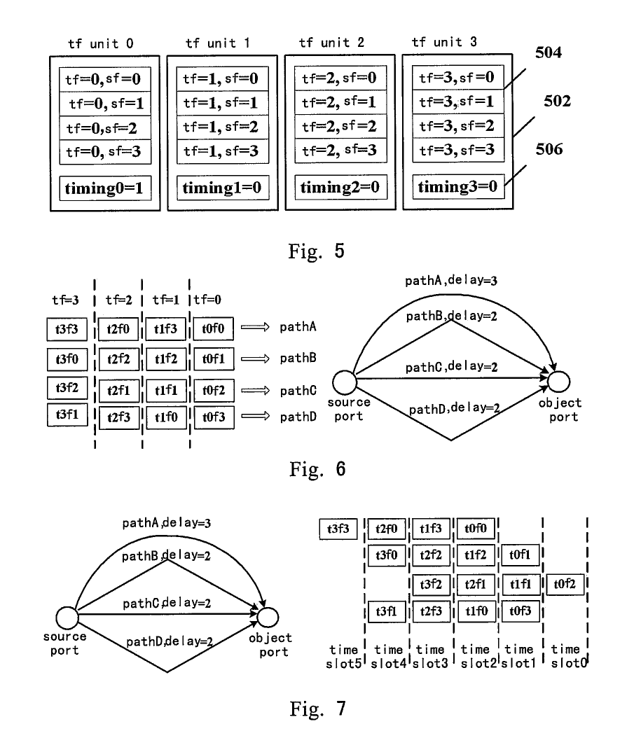

FIG. 5 is a schematic diagram showing the structure of a reorder cell buffer according to a preferred embodiment of the present invention. Assuming the PATH_NUM is 4 and the SKEWmax is 2 cell periods, and then 2 bits for the time flags (tf) and 2 bits for the sequence flags (sf) are required. Each reordering buffer includes 4 serial number units (tf unit) 502 for the time flag, and each serial number unit 502 for the time flag includes 4 reorder units 504 and 1 timing unit 506. The reorder unit 504 buffers the multiple pieces of the enqueue information of one cell, such as an address of a cell in the share buffer and the cell priority. The time flag corresponding to the multiple pieces of the enqueue information of each cell determines to occupy which tf unit 502 and the sequence flag carried by the cell determines to occupy which reorder unit 504 in the tf unit 502.

The timing unit 506 is a timing ager. For the tf unit 502, if 4 reorder units 504 are not occupied at all, the corresponding timing unit 506 will be then set to zero. If any of the 4 reorder units 504 is occupied (or effective), the corresponding timing unit 506 will begin to count, and add 1 to each cell slot. If the timing unit 506 is equal to the maximum Tth (herein, Tth=2), it means the corresponding tf unit 502 has been reordered, and the corresponding effective reorder unit should be read, and then the timing unit 506 should be set to zero.

FIG. 6 is schematic diagram showing the source module sending cells to the object module via four paths having different time delays according to a preferred embodiment of the present invention, in which the cell having the time flag of 0 (tf=0) and the sequence flag of 0 (sf=0) is referred to as t0f0 for short, other cells will be referred to in short similarly. FIG. 6 shows a single stream (i.e., only one source module and one object module in the system) as an example, illustrating the time flag and the sequence flag of each cell and their paths in the case that the source module sends 16 cells. Herein, the number of the path PATH_NUM is 4 and the maximum of the differences between the path delays SKEWmax is 2 cell periods.

FIG. 7 schematically shows a rule for cells reaching the object module according to the preferred embodiment of the present invention, which is an example in relation to the single stream (i.e., only one source module and one object module in the system) in FIG. 6. It can be seen, while each cell waits for 3 cell slots at most after reaching the object module, the group of cells having the same time flag will all arrive. At the same time, the reorder for the group of cells having the time flag is finished. All the reorder units read from the reordered tf units are in the small-to-big turn of the sequence flags, and then the timing unit is set to zero.

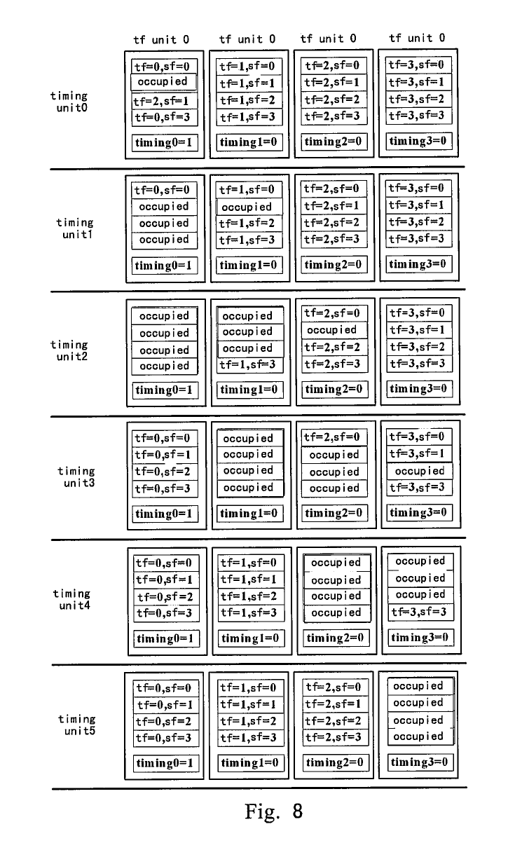

FIG. 8 is a schematic diagram showing a reorder process of the cells received by an object module according to a preferred embodiment of the present invention. In slot 2, the ts unit 0 is reordered and reads all the reordering units in the ts unit 0 in the order from sequence flag 0 to sequence flag 3 and at the same time the timing unit of the ts unit 0 is set to zero. In slot 3, the ts unit 1 is reordered and reads all the reordering units in the ts unit 1 in the order from sequence flag 0 to sequence flag 3 and at the same time the timing unit of the ts unit 1 is set to zero. In slot 4, the ts unit 2 is reordered and reads all the reordering units in the ts unit 2 in the order from sequence flag 0 to sequence flag 3 and at the same time the timing unit of the ts unit 2 is set to zero. In slot 5, the ts unit 3 is reordered and reads all the reordering units in the ts unit 3 in the order from sequence flag 0 to sequence flag 3 and at the same time the timing unit of the ts unit 3 is set to zero.

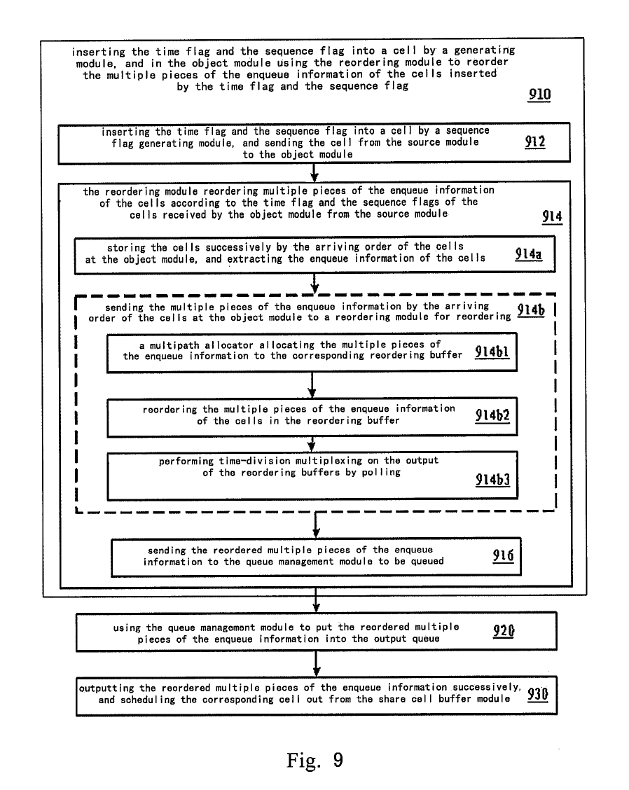

FIG. 9 is a flow chart showing a method for cell processing according to an embodiment of the present invention. The method for cell processing will be described as below:

At step 910, insert the time flag and the sequence flag into a cell by a sequence flag generating module, and in the object module use the reordering module to reorder the multiple pieces of the enqueue information of the cells inserted by the time flag and the sequence flag.

And at step 930, output the reordered multiple pieces of the enqueue information successively, and schedule the corresponding cell out from the share cell buffer module.

Preferably, the method for cell processing can also include step 920 between step 910 and step 930.

At step 920, the queue management module is used to put the reordered multiple pieces of the enqueue information into the output queue.

In accordance with some embodiments, step 910 can further include the following steps:

At step 912, the time flag and the sequence flag are inserted into a cell by a sequence flag generating module, and the cell from the source module is sent to the object module. The cells of the same stream outputted at the same time can be inserted by the same time flag. The time flags are arranged by a unified rule and the number of the time flags is at least twice of the cell period included in the maximum delay difference between two different paths. Whereas, the cells, which are in the same stream and outputted at the same time, can be inserted by different sequence flags. And, the sequence flags can be arranged by a unified rule, with their number equal to number of the paths from one source module to one object module.

At step 914, the reordering module reorders multiple pieces of the enqueue information of the cells according to the time flag and the sequence flags of the cells received by the object module from the source module.

At step 916, the reordered multiple pieces of the enqueue information are sent to the queue management module to be queued.

In this method according to some embodiments, the reordering module reorders the multiple pieces of the enqueue information of the cells according to the time flag and the sequence flag, and this step may include the following steps:

At step 914a, the input processor module stores the cells successively into the share cell buffer module by the arriving order of the cells at the object module, and extracts the enqueue information of the cells.

At step 914b, the input processor module sends the multiple pieces of the enqueue information to the reordering module by the arriving order of the cells at the object module to a reordering module for reordering.

Herein, step 914b may further include the following steps:

At step 914b1, the multipath allocator allocates the multiple pieces of the enqueue information from the input processor module to the corresponding reordering buffer in accordance with the serial number of the source module.

At step 914b2, for each reordering buffer, in the case that one cell having a certain time flag is the unique one having such a flag, the reordering buffer can start to time the time flag. And when the timing value becomes equal to or more than the maximum time delay, the reordering buffer determines whether all of the multiple pieces of the enqueue information of the cells in a certain time range prior to that of “time flag” have been outputted. If so, it outputs the multiple pieces of the enqueue information of the cell having the time flag; if not, it enforces to output the multiple pieces of the enqueue information of the cells in the prior time range that have not been outputted, and then outputs the multiple pieces of the enqueue information of the cell having the time flag.

At step 914b3, the multiplexer performs the time-division multiplexing on the multiple pieces of the enqueue information output of the reordering buffers by polling.

At step 914b2, the reordering buffer times the multiple pieces of the enqueue information by using the aging counter.

According to some embodiments of the present invention, the RCB spaces occupied can be much less than that of the prior art, which may be around 36×4×72 byte=81 Kb. According to some embodiments of the present invention, the cells are inserted by the time flags and the sequence flags in the source module, the multiple pieces of the enqueue information for the cells are ordered in the object module according to the time flags and the sequence flags and then the cells are enqueued and scheduled. Moreover, in some embodiments of the present invention, the time for each cell occupying RCB during reorder can be strictly controlled. For example, the reorder operation can be done after the occupied time reaches the limit defined in the algorithm, and the demand for RCB buffer capacity can be lowered, whereby it solves the significant problem in extensibility design of the multi-stage switch fabric with large capacity.

It should be appreciated that the descriptions above are just for some embodiments of the present invention, and are not limitations to the present invention. It will be apparent to those skilled in the art that various modifications and variations can be made. Thus, it is intended that the present invention covers the modifications and variations of this invention provided they come within the scope of the appended claims and their equivalents.

What is claimed is:

1. A method for cell reordering, comprising the steps of:
inserting time flags and sequence flags into cells by a sequence flag generating module;
sending the cells from a source module to an object module; and
reordering the multiple pieces of the enqueue information of the cells by a reordering module according to the time flags and the sequence flags.

2. The method according to claim 1, wherein the step of inserting time flags and sequence flags into cells by a sequence flag generating module further comprises:
the sequence flag generating module inserting the same time flag into the cells of the same stream outputted at the same time; and
the sequence flag generating module inserting different sequence flags into the cells of the same stream outputted at the same time.

3. The method according to claim 2, wherein
the time flags are arranged by a unified rule and the number of the time flags is at least twice of the number of cell period included in the maximum delay difference between two different paths, and
the sequence flags are arranged by a unified rule, with the number thereof equal to the number of paths from the source module to the object module.

4. The method according to in claim 1, wherein the step of reordering the multiple pieces of the enqueue information of the cells by a reordering module according to the time flags and the sequence flags further comprises the steps of:
storing the cells successively into a share cell buffer module by the arriving order of the cells at the object module and extracting the enqueue information of the cells by an input processor module; and
sending the multiple pieces of the enqueue information by the arriving order of the cells at the object module to the reordering module for reordering by the input processor module.

5. The method according to claim 4, wherein the step of sending the multiple pieces of the enqueue information by the arriving order of the cells at the object module to the reordering module for reordering by the input processor module further comprises the steps of:
allocating the multiple pieces of the enqueue information from the input processor module to the corresponding reordering buffer according to the serial number of the source module by a multipath allocator;
starting to time the time flag by each reordering buffer in the case that a cell having a unique time flag, wherein,
when a timing value becomes equal to or larger than the maximum time delay, the reordering buffer determines whether all of the multiple pieces of the enqueue information of the cells in a time range prior to the time flag have been outputted, and if so, outputs the enqueue information of the cell having the time flag, if not, forcedly outputs the multiple pieces of the enqueue information of the cells which are not outputted till then, and outputs the enqueue information of the cell having the time flag; and
performing the time-division multiplexing on the output of the reordering buffers by polling by a multiplexer.

6. The method according to claim 5, wherein the step of reordering the multiple pieces of the enqueue information of the cells by a reordering module according to the time flags and the sequence flags further comprises:
sending the multiple pieces of the reordered enqueue information by the reordering module to a queue management module for queuing.

7. The method according to claim 5, wherein in the step of starting to time the time flag by each reordering buffer in the case that a cell having a unique time flag, the time flag is timed by using an aging counter.

8. A method for cell processing, comprising:
inserting time flags and sequence flags into cells by a sequence flag generating module;
reordering the multiple pieces of the enqueue information of the cells inserted by the time flags and the sequence flags in an object module by a reordering module; and
outputting the multiple pieces of the enqueue information reordered successively and scheduling the corresponding cells out from a share cell buffer module.

9. The method according to claim 8, further comprising the following step between the step of inserting time flags and sequence flags into cells by a sequence flag generating module, and reordering the multiple pieces of the enqueue information of the cells inserted by the time flags and the sequence flags in the object module by a reordering module and the step of outputting the multiple pieces of the enqueue information reordered successively and scheduling the corresponding cells out from the share cell buffer module:
queuing the reordered multiple pieces of the enqueue information into an output sequence by a queue management module.

10. The method according to claim 8, wherein the step of inserting time flags and sequence flags into cells by a sequence flag generating module, and reordering the multiple pieces of the enqueue information of the cells inserted by the time flags and the sequence flags in the object module by a reordering module further comprises the steps of:
inserting the time flags and the sequence flags into the cells by the sequence flag generating module and sending the cells from the source module to the object module; and
reordering the multiple pieces of the enqueue information of the cells by the reordering module according to the time flags and the sequence flags of the cells received by the object module from the source module.

11. The method according to claim 8, wherein the step of inserting time flags and sequence flags into cells by the sequence flag generating module further comprises the steps of:
inserting the same time flag into the cells of the same stream outputted at the same time by the sequence flag generating module; and
inserting different sequence flags into the cells of the same stream outputted at the same time by the sequence flag generating module.

12. The method according to claim 11, wherein,
the time flags are arranged by a unified rule and the number of the time flags is at least twice of the number of cell period included in the maximum delay difference between two different paths; and
the sequence flags are arranged by a unified rule, with the number thereof equal to the number of paths from the source module to the object module.

13. The method according to claim 10, wherein the step of reordering the multiple pieces of the enqueue information of the cells by the reordering module according to the time flags and the sequence flags of the cells received by the object module from the source module further comprises the steps of:
storing the cells successively into a share cell buffer module by the arriving order of the cells at the object module and extracting the enqueue information of the cells by an input processor module; and
sending the multiple pieces of the enqueue information by the input processor module by the arriving order of the cells at the object module to a reordering module for reordering.

14. The method according to claim 13, wherein the step of sending the multiple pieces of the enqueue information by the input processor module by the arriving order of the cells at the object module to a reordering module for reordering further comprises the steps of:
allocating the multiple pieces of the enqueue information from the input processor module to the corresponding reordering buffer according to the serial number of the source module by a multipath allocator;
starting to time the time flag by each reordering buffer, in the case that one cell having a certain time flag is the unique one having such a flag, wherein,
when the timing value becomes equal to or larger than the maximum time delay, the reordering buffer determines whether all of the multiple pieces of the enqueue information of the cells in a certain time range prior to that of the time flag have been outputted, and if so, outputs the enqueue information of the cell having the time flag; if not, enforces to output the multiple pieces of the enqueue information of the cells in the prior time range that have not been outputted, and outputs the enqueue information of the cell having the time flag; and
performing the time-division multiplexing on the output of the reordering buffers by polling by the multiplexer.

15. The method according to claim 14, wherein the step of inserting time flags and sequence flags into cells by a sequence flag generating module, and reordering the multiple pieces of the enqueue information of the cells inserted by the time flags and the sequence flags in the object module by a reordering module further comprises the step of:
sending the multiple pieces of the enqueue information reordered to a queue management module to be queued.

16. The method according to claim 14, wherein in the step of starting to time the time flag by each reordering buffer, in the case that one cell having a certain time flag is the unique one having such a flag, the time flag is timed by an aging counter.

17. An apparatus for cell processing, comprising:
a reordering module, for receiving the multiple pieces of the enqueue information of cells from an input processor module and reordering the multiple pieces of the enqueue information of the cells according to time flags and sequence flags carried by the cells.

18. The apparatus according to claim 17, further comprising:
a share cell buffer module, for storing the cells received by the input processor module.

19. The apparatus according to claim 17, further comprising:
an input processor module, for receiving cells from a source module, storing the cells into a share cell buffer module and extracting the multiple pieces of the enqueue information of the cells, and outputting the multiple pieces of the enqueue information of the cells into the reordering module by the arriving order of the cells at an object module.

20. The apparatus according to claim 17, wherein the reordering module further comprises:
a queue management module, for receiving the multiple pieces of the enqueue information of the cells reordered by the reordering module and queuing the multiple pieces of the enqueue information into an output sequence.

21. The apparatus according to claim 17, wherein the reordering module further comprises:
a multipath allocator, for receiving the multiple pieces of the enqueue information of the cells from the input processor module and allocating the multiple pieces of the enqueue information to the corresponding reordering buffer according to the serial number of the source module;
a plurality of reordering buffers, for reordering the multiple pieces of the enqueue information, each corresponding to one source module; and
a multiplexer, for performing the time-division multiplexing on the output enqueue information of the reordering buffers by polling.

22. The apparatus according to claim 21, wherein the reordering buffer is configured such that in the case that a cell have a unique time flag, it starts to time the time flag, and when a timing value becomes equal to or larger than the maximum time delay, the reordering buffer determines whether all of the multiple pieces of the enqueue information of the cells in a certain time range prior to that of the time flag have been outputted, and if so, outputs the enqueue information of the cell having the time flag; if not, enforces to output the multiple pieces of the enqueue information of the cells in the prior time range that have not been outputted, and then outputs the enqueue information of the cell having the time flag.

23. The apparatus according to claim 22, wherein the reordering buffer is provided with an aging counter for timing the time flag.
